(19) United States
(12) Patent Application Publication
(10) Pub. No.: US 2026/0093496 A1
(43) Pub. Date: Apr. 2, 2026

(54) MACHINE LEARNING FOR BRANCH ANALYSIS

(71) Applicants: Xilinx, Inc., San Jose, CA (US); ADVANCED MICRO DEVICES, INC., Santa Clara, CA (US)

(72) Inventors: Linus Matthias Witschen, Dublin (IE); Tushar Chouhan, Signature Crest (SG); Thomas Preusser, Dresden (DE); Haris Javaid, Bedok South Avenue (SG); John Kalamatianos, Boxborough, MA (US)

(21) Appl. No.: 18/900,449

(22) Filed: Sep. 27, 2024

(51) Int. Cl. G06F 9/38; G06F 9/30

(52) U.S. Cl. CPC G06F 9/3848; G06F 9/3005

(57) ABSTRACT

A processing unit executes a sequence of instructions comprising a branch instruction and selects a target branch predictor for the branch instruction from a plurality of branch predictors. The selection is based on a language model trained on a set of training instruction sequences that comprise branch instructions. The target branch predictor then determines the outcome of the branch instruction. The language model is trained to identify the branch instructions as having easy-to-predict outcomes or hard-to-predict outcomes based on sequence of instructions. Information generated by the language model is provided to a branch prediction unit, which uses the information to determine whether branch instructions are easy-to-predict or hard-to-predict.

### BACKGROUND

Processing units, such as central processing units (CPUs), typically implement an instruction pipeline architecture that subdivides the processing of an instruction into multiple stages that are linked into a pipeline. For example, a pipeline can include four stages to perform four different processing steps: fetching the instruction, decoding the instruction, executing the instruction, and writing results back to memory or registers. Other pipelines can include more or fewer stages that perform more or fewer processing steps. Implementing the instruction pipeline architecture allows multiple instructions to be processed concurrently or in parallel. For example, a processing unit that implements a four-stage pipeline can concurrently fetch one instruction, decode a previously fetched instruction, execute a previously decoded instruction, and write the results of a previously executed instruction back to memory or registers.

Branch instructions direct the program flow to different instructions depending on whether a condition is satisfied. For example, a branch-target instruction is executed if the condition is satisfied (and the branch is taken) and the branch instruction's sequential successor instruction is executed if the condition is not satisfied (and the branch is not taken). In the absence of a known or predicted outcome of the condition, the processing unit would not be able to fetch the next instruction in the sequence until the execution of the branch instruction is complete. Thus, concurrent execution of instructions in a pipeline may have to stall at a branch instruction because the outcome of its condition is unknown until the branch instruction has completed its execution stage. Branch prediction is therefore used to predict the outcome of the condition so that the next instruction (or sequence of instructions) along the predicted branch can be fetched and speculatively executed. If the prediction is correct, the branch instruction does not introduce any additional delay into the pipeline. If the prediction is incorrect, the speculatively executed instructions are flushed and the pipeline resumes execution along the correct branch after a delay that depends on the length of the pipeline.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 illustrates a processing system configured to train a model to identify and categorize hard-to-predict branch instructions and then use the trained model for branch prediction according to some embodiments.

FIG. 2 illustrates a system that implements a method of training a language model to identify and categorize hard-to-predict branch instructions according to some embodiments.

FIG. 3 illustrates distributions of characteristics of branch instructions at different stages of training a language model to identify and categorize branch instructions according to some embodiments.

FIG. 4 illustrates a system that implements a method of performing branch prediction for hard-to-predict branch instructions according to some embodiments.

FIG. 5 illustrates a system that implements a method of tokenizing and re-tokenizing branch instructions to identify dependencies between subsets of instructions according to some embodiments.

FIG. 6 illustrates a method of predicting outcomes of branch instructions using branch predictors that are selected based on the difficulty of predicting the outcome of the branch instructions, according to some embodiments.

FIG. 7 illustrates a method of training a language model to categorize branch instructions based on the difficulty of predicting the outcome of the branch instructions, according to some embodiments.

### DETAILED DESCRIPTION

Conventional branch predictors predict the outcomes of branch instructions based on branch history information that indicates previous outcomes of the branch instructions. State-of-the-art branch predictors, such as a TAgged GEometric length (TAGE) predictor, successfully predict the outcomes of branch instructions in many contexts by detecting correlations between prior control flow history (e.g., the branch direction or branch target) and the outcomes of fetched branch instructions. However, the accuracy of the state-of-the-art branch predictors can be degraded by a subset of branches that are referred to herein as hard-to-predict branches. A hard-to-predict branch has a difficulty of prediction that is greater than a difficulty of predicting other, easy-to-predict branches. A branch outcome can be hard to predict by conventional branch predictors if the branch outcome does not depend on prior control flow history. For example, data dependent branch outcomes can be hard to predict. A branch outcome can also be hard to predict if it correlates with control flow history that is not, or only partially, captured by the branch predictor implementation. Some branch predictor implementations track outcomes or targets of all prior branches (global control flow) and others track the outcomes or targets of the same branch (local control flow). A branch outcome can be hard to predict if it is self-correlated (local) but the branch predictor only tracks the global control flow history. Typically, hard-to-predict branches exhibit higher misprediction rates than other, easy-to-predict branches when predicted by control-flow based branch predictors.

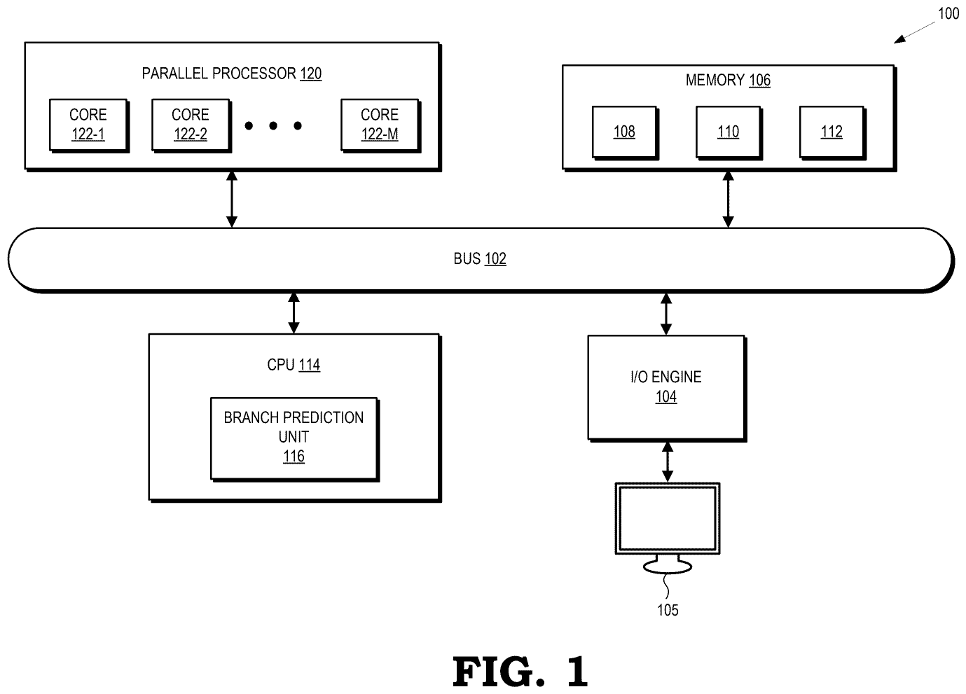

FIGS. 1-5 depict systems and methods of identifying and categorizing hard-to-predict branches based on a language model trained on instruction sequences including the branch instructions. In some embodiments, the hard-to-predict branches are also identified or categorized based on prior control flow history (e.g., the branch direction or branch target). The language model is pretrained using one or more decoders (which can be referred to as pretraining decoders) to apply corresponding tasks to a sequence of instructions including one or more branch instructions. Examples of pretraining tasks implemented by decoders include predicting randomly masked instructions in the sequence of instructions, predicting outcomes of branch instructions in variable length samples of instructions drawn from the sequence, and identifying dependencies between instructions in the sequence. The pretrained language model is then trained to identify hard-to-predict branch instructions, e.g., using a training dataset that includes a sequence of instructions including branch instructions, branch direction predictions made by a branch predictor, actual outcomes of the branch instructions, or performance metrics indicating how hard-to-predict the branch is. A first decoder can use the trained language model to determine whether a branch instruction is hard-to-predict. The language model can further be trained to categorize the hard-to-predict branch instructions, e.g., using unsupervised learning to detect clusters within the set of hard-to-predict branch instructions. A second decoder can use the trained language model to further categorize branch instructions identified as hard-to-predict by the first decoder. Information generated by the first and/or second decoders is used to fine-tune the pretrained language model.

The branch prediction categories generated based on the trained language model, e.g., using the second decoder, can be used online (at runtime) to select branch predictors. At runtime, branch categorization, generated by the trained language model, is used to select one of a plurality of branch predictors to predict branch outcomes. The category of a hard-to-predict branch instruction is provided to the branch predictor. The branch predictor uses this information to determine which of its multiple predictor components should be used to predict outcomes of the fetched branch instructions. For example, the branch prediction unit can include a TAGE branch predictor and one or more branch predictors associated with different categories of hard-to-predict branch instructions. In response to fetching a branch instruction, the branch predictor selects one of its multiple predictor components based on the information received from the trained language model. In some cases, the selection information is communicated to the branch predictor via modified instruction set architecture (ISA) instructions. For example, instructions can provide hints to the microarchitecture that indicate which predictor to choose. Routing the hard-to-predict branch instructions to a hard-to-predict branch predictor component in the appropriate category can improve utilization of the available branch predictor area and increases the accuracy of branch outcome prediction. Furthermore, the hard-to-predict branch instructions can be filtered prior to subsequent clustering and characterization of the hard-to-predict branch instructions, potentially reducing state pollution in other branch predictors such as those used for easy-to-predict branches.

The branch prediction categories can also be used off-line (at design time) to develop new branch predictors or category-specific branch prediction components. At design time, characteristics of the categories of hard-to-predict branch instructions generated by the language model can be provided to processor architects, who use this information to design branch predictors that are better suited to predict the various categories of hard-to-predict branch instructions.

FIG. 1 illustrates a processing system 100 configured to train a model to identify and categorize hard-to-predict branch instructions and then use the trained model for branch prediction according to some embodiments. The processing system 100 includes a bus 102 implemented with circuitry that supports communication between entities implemented in the processing system 100. Some implementations of the processing system 100 include other buses, bridges, switches, routers, and the like, which are not shown in FIG. 1 in the interest of clarity. An input/output (I/O) engine 104 is implemented with circuitry that handles input or output operations associated with display 105, as well as other elements of the processing system 100 such as keyboards, mice, printers, external disks, and the like. The I/O engine 104 is coupled to the bus 102 so that the I/O engine 104 can communicate with other entities in the processing system 100 by exchanging signals over the bus 102.

Processing system 100 also includes or has access to a memory 106 or other storage component implemented using a non-transitory computer-readable medium, for example, a dynamic random-access memory (DRAM). However, in implementations, the memory 106 is implemented using other types of memory including, for example, static random-access memory (SRAM), nonvolatile RAM, and the like. According to implementations, the memory 106 includes an external memory implemented external to the processing units implemented in the processing system 100. Some embodiments of the memory 106 store information representing instructions such as program code 108 for one or more applications (e.g., graphics applications, compute applications, machine-learning applications), data 110 that is consumed by the program code 108, and results 112 produced by executing the program code 108.

The processing system 100 includes a central processing unit (CPU) 114 that is connected to the bus 102 to communicate with other entities in the processing system 100, such as the memory 106. The CPU 114 implements circuitry such as a plurality of processor cores (not shown in FIG. 1 in the interest of clarity) that execute instructions concurrently or in parallel. In some implementations, one or more of the processor cores operate as single-instruction-multiple-data (SIMD) units that perform the same operation on different data sets. The CPU 114 is configured to execute instructions such as the program code 108 for one or more applications (e.g., graphics applications, compute applications, machine-learning applications), which is stored in the memory 106. The CPU 114 can consume data 110 and store information in the memory 106 such as the results 112 of the executed instructions.

A branch prediction unit 116 is implemented in the CPU 114 using circuitry configured to predict outcomes of branch instructions so that the program flow can be speculatively directed to a branch target instruction or successor instruction based on the predicted outcome. The branch prediction unit 116 includes circuitry configured to implement multiple branch predictors (not shown in FIG. 1 in the interest of clarity) such as one or more branch predictors that are configured to predict outcomes of easy-to-predict branch instructions and one or more branch predictors that are configured to predict outcomes of hard-to-predict branch instructions. In operation, the CPU 114 (or one or more of the processor cores in the CPU 114) executes a sequence of instructions that includes one or more branch instructions. In response to receiving a branch instruction in the program flow, the branch prediction unit 116 selects a target branch predictor for the branch instruction based on a language model trained to identify hard-to-predict branch instructions. For example, the branch prediction unit 116 can select the easy-to-predict branch predictor as the target branch predictor if, based on the trained language model, the branch instruction is identified as easy-to-predict. For another example, the branch prediction unit 116 can select one of the hard-to-predict branch predictors as the target branch predictor if, based on the trained language model, the branch instruction is identified as hard-to-predict. The branch prediction unit 116 can also select one of the hard-to-predict branch predictors based on categorization performed by the language model. For example, the branch prediction unit 116 can select, based on the trained language model, one of the hard-to-predict branch predictors that is associated with a target category that corresponds to a category of the branch instruction. The branch predictor 116 then predicts an outcome of the branch instruction using the target branch predictor associated with the target category.

Some embodiments of the processing system 100 include a parallel processor 120. The parallel processor 120 can include, for example, a GPU, a general-purpose GPU (GPGPU), a neural processing unit (NPU), an intelligence processing unit (IPU) or other vector processor or type of parallel processor. The parallel processor 120 includes circuitry to implement one or more processor cores 122-1 . . . M that each operate as a compute unit configured to perform one or more operations based on one or more instructions received by the parallel processor 120. Although three processor cores 122 are shown in FIG. 1, more or fewer processor cores 122 can be implemented in other embodiments of the parallel processor 120. The compute units in the processor cores 122 are implemented as circuitry for one or more single-instruction, multiple data (SIMD) units that perform the same operation on different data sets to produce one or more results.

In the illustrated embodiment, the parallel processor 120 is configured to train a language model to identify and categorize hard-to-predict branch instructions. To train the language model, the parallel processor 120 accesses a sequence (or set) of instructions that includes one or more branch instructions. The source of the information can be internal or external to the processing system 100. For example, information representing the sequence of instructions can be stored as data 110 in the memory 106. For another example, the information representing the sequence of instructions can be received from an external entity via the I/O engine 104. The parallel processor 120 then executes program code (e.g., program code 180 stored in the memory 106) to train the language model to identify branch instructions as having easy-to-predict outcomes or hard-to-predict outcomes based on the sequence of instructions. In some embodiments, the parallel processor 120 also trains the language model to identify the hard-to-predict outcomes based on a prior control flow history of the branch instructions in the sequence of instructions or other information provided for training the language model, as discussed herein. The parallel processor 120 then provides information generated by the language model to the branch prediction unit or processor architect, which can use this information to determine whether branch instructions are easy-to-predict or hard-to-predict.

Although the parallel processor 120 performs the training operations in the illustrated embodiment, other processor units can perform some or all the training of the language model in other embodiments. For example, a portion of the language model training (such as the pretraining of the language model discussed herein) can be performed using one or more other processors, which may be implemented external to the processing system 100. The pretrained language model can then be provided to the parallel processor 120 for further training. For another example, the language model can be trained using one or more external processors and then information representing the trained language model can be provided to the branch prediction unit 116.

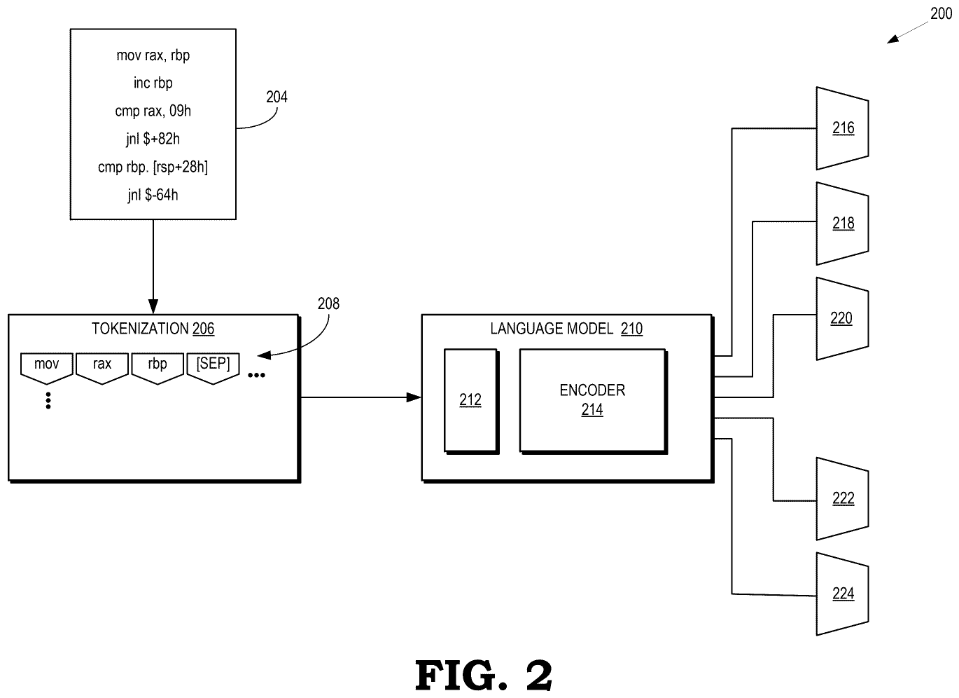

FIG. 2 illustrates a system 200 that implements a method of training a language model 202 to identify and categorize hard-to-predict branch instructions according to some embodiments. The system 200 is implemented in some embodiments of the processing system 100 shown in FIG. 1.

An instruction sequence 204 is provided to the system 200. In the illustrated embodiment, the instruction sequence 204 is part of a set of instruction sequences that include one or more branch instructions. Circuitry 206 is configured to tokenize the instruction sequence. For example, the circuitry 206 tokenizes the instruction mov rax, rbp into a set 208 of tokens that represent the mov instruction, the rax register, the rbp register, and the line break or separation [SEP] between the instruction and the following instruction. The set 208 of tokens is then provided to language model circuitry 210 that includes circuitry 212 for mapping the tokens in the set 208 to corresponding embeddings. The embeddings generated by the circuitry 212 are provided to an encoder 214 for the language model. The encoder 214 can be pretrained based on one or more predefined tasks including, but not limited to, branch-focused mask language modeling (MLM), context-aware branch prediction, and dependency prediction, as discussed herein.

A decoder 216 is configured to implement branch-focused MLM to pretrain the encoder 214 of the language model to understand the general code structure or syntax of the language used to generate the instruction sequence 204. For example, the decoder 216 can be configured to pretrain the encoder 214 to understand assembly language, opcode sequences, and the like. Some embodiments of the decoder 216 pretrain the language model to predict randomly masked parts of the input stream including the set 208 of tokens. A data splitting scheme can be used so that each pretraining sample includes a variable length or number of non-branch instructions along with at least one branch instruction. Bidirectional information flow is supported in the pretraining task, which has been shown to improve the predictive capabilities of the language model relative to strictly causal or unidirectional language representations.

A decoder 218 is configured to perform a context-aware branch prediction task to pretrain the encoder 214 to identify dependent contexts that affect the behavior of branch instructions. In some embodiments, the decoder 218 is used to pretrain the encoder 214 to support language models that interpret the context of a given sequence of instructions and predict whether a branch is taken or not based on the interpretation provided by the language model. The set 208 includes tokens representing a sequence of instructions that includes branch and non-branch instructions. Training samples include varying lengths or numbers of sequences that can include other branch and/or non-branch instructions before and/or after the branch instruction. The task of the language model can be to perform a binary classification (such as predicting whether the branch is taken or whether the branch is hard or easy to predict, as performed by decoder 222 and discussed below) or other tasks such as estimating how hard the branch is to predict. If the task is a binary classification, the outcome of the pretraining task implemented by the decoder 218 is one of two options such as whether the branch instruction is taken or not taken or the branch instruction is easy-to-predict or hard-to-predict. Otherwise, the outcome can be one of a set of categories or a predicted value such as an indication of how hard the branch is to predict. In some embodiments, the decoder 218 implements a supervised learning task that pretrains the language model based on instruction sequences 204 generated by a simulator.

A decoder 220 is configured to identify important or relevant relationships between different instructions or other portions of the instruction sequence 204. The decoder 220 can pretrain the language model to identify a context and dependent instructions that are relevant to predicting whether a branch is taken. For example, CPU flags, such as the flag bits stored in a FLAGS register, can create dependencies between instructions and these dependencies can be relevant to predicting whether branches are taken or not. Thus, pretraining the language model based in part on the values of the CPU flags can improve the prediction accuracy of the language model. The decoder 220 applies a “re-tokenization” task to ingest embeddings of the tokens in the set 208 that are provided by the encoder 214. The decoder 220 combines embeddings corresponding to the tokens that make up each instruction and then the decoder 220 generates a single representation of each instruction. A new positional embedding layer is trained such that the new combined representative embedding for each instruction is added to a corresponding positional embedding. The decoder 220 treats each instruction as a single token and computes a self-attention matrix followed by a soft-max layer. Relevance scores for pairs of instructions are generated by the self-attention matrix and the soft-max output provides a probabilistic interpretation of the self-attention scores. The self-attention matrix can be compared to a ground truth that contains ideal relevant scores of the pairs of instructions. In some embodiments, the ground truth is generated deterministically by encoding mutually dependent pairs of instructions as 1 and mutually independent instructions as 0. A function analogous to the functions that are used to train regression problems can be used to quantify the loss and pretrain the language model.

Pretraining the language model incorporates or builds into the model qualities that can support processing and analyzing instruction sequences using the language model. Pretraining can be performed using one or more of the decoders 216, 218, 220, either alone or in combination. For example, if the three decoders 216, 218, 220 are used to pretrain the language model, the language model would be pretrained to understand the general code structure and syntax of the language being used to generate the instruction sequence 204, identify dependent contexts that affect the behavior of branch instructions, and identify relationships between different parts of the instruction sequence 204. Training of the encoder 214 of the language model can also be performed based on the downstream tasks performed by branch prediction unit such as the branch prediction unit 116 shown in FIG. 1. Some embodiments of the encoder 214 are trained to perform classification of hard-to-predict branch instructions and/or characterization of hard-to-predict branch instructions.

Some embodiments of the decoder 222 are trained to identify hard-to-predict branch instructions such as branch instructions that are hard to predict using control flow-based branch predictors such as TAGE. For example, the decoder 222 can be trained as a supervised, binary classification task based on a loss function such as a categorical cross-entropy function. Other techniques can be used to generate labeled datasets in some embodiments. For example, labelled datasets can be generated using conditional entropy techniques, transition-rate techniques, and the like. A labeled dataset can be generated using a simulator that provides a metric for classifying branches as hard-to-predict or easy-to-predict for a predetermined branch prediction algorithm, such as TAGE. The labeled dataset is then provided to train the encoder 214 to classify hard-to-predict branch instructions using the metric as the ground truth, which can be based on the entropy of the branch history that is used by the predetermined branch prediction algorithm. This approach may have at least three benefits: (1) confidence that the model accurately classifies hard-to-predict branch instructions because a baseline implementation exists, (2) the model learns the characteristics of the easy-to-predict and hard-to-predict branch instructions, and (3) the model can be used as a filter for hard-to-predict branch instructions prior to subsequent clustering and characterization of the hard-to-predict branch instructions.

The decoder 224 can be used to generate information indicating the intrinsic characteristics of a hard-to-predict branch instruction. In some embodiments, the embeddings of the previously identified hard-to-predict branch instructions are used to perform clustering, e.g., using an unsupervised learning algorithms such as K-means clustering, a Gaussian mixture model, and the like. In some cases, an expected number of clusters is provided to the system 200 as a hyperparameter. This optimization can be semi-supervised, e.g., by quantifying a distance between centroids of the clusters or distances between different distributions making up the clusters using Kullback-Leibler (KL) divergence. An expert human agent can then iteratively optimize the hyperparameter until an equal or “sensible” distance metric is observed between the pairs of clusters. In some embodiments, identification of optimal numbers of clusters is performed using automated techniques such as the elbow method or the silhouette method so that intervention by an expert human is not required.

In some embodiments, the decoder 224 performs characterization of branch instructions that have been identified as hard-to-predict by the decoder 222. The decoder 224 bypasses characterizing branch instructions that have not been identified as hard-to-predict or have been identified as easy-to-predict. Thus, the higher-order embedding obtained as the output of the encoder 214 after training by the decoder 222 is used as input to the decoder 224. In some cases, the decoder 224 performs a clustering task to identify distinct clusters of hard-to-predict branch instructions using an unsupervised learning algorithm. The information indicating intrinsic characteristics of hard-to-predict branch instructions (or clusters of hard-to-predict branch instructions) can be provided to a branch prediction unit (at runtime).

In some embodiments, the information indicating the intrinsic characteristics of the hard-to-predict branch instructions can be provided to CPU architects or designers for use at design time. For example, the CPU architects can use the intrinsic characteristics to design branch predictors that are better at predicting the outcomes of hard-to-predict branch instructions that have these (or similar) characteristics. The information can include information indicating outlier branch instructions that may potentially pollute the states of easy-to-predict branch predictors such as TAGE predictors. The CPU architects can then design hard-to-predict branch predictors to perform branch prediction on branch instructions having the characteristics of the outlier branch instructions.

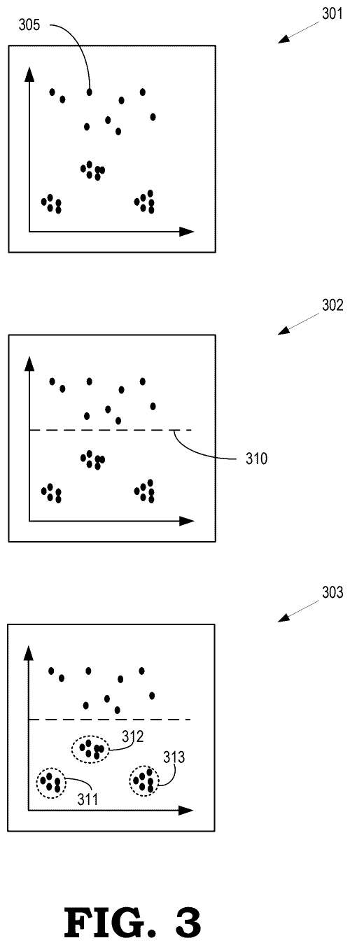

FIG. 3 illustrates distributions 301, 302, 303 of characteristics of branch instructions at different stages of training a language model to identify and categorize branch instructions according to some embodiments. The distributions 301, 302, 303 correspond to stages of the training (or pretraining) performed by some embodiments of the encoder 214 using one or more of the decoders 216, 218, 220, 222, 224 shown in FIG. 2. In the illustrated embodiment, the distributions 301, 302, 303 are two-dimensional representations of a set of branch instructions 305 (only one indicated by a reference numeral in the interest of clarity). The dimensions correspond to different characteristics of the corresponding branch instructions. Although two dimensions are indicated in FIG. 3, any number of dimensions corresponding to any number of characteristics can be used in other embodiments.

In the illustrated embodiment, the distribution 301 represents the set of branch instructions 305 prior to or after pretraining of the language model used to predict the outcomes of branch instructions. The distribution 302 represents the set of branch instructions 305 after training of the language model to identify easy-to-predict and hard-to-predict branch instructions. Training of the language model can be performed by a decoder such as the decoder 222 shown in FIG. 2. In the illustrated embodiment, the language model is trained to identify branch instructions 305 above the line 310 as easy-to-predict and to identify branch instruction 305 below the line 310 as hard-to-predict. The distribution 303 represents the set of branch instructions 305 after training the language model to categorize the hard-to-predict branch instructions, e.g., using the decoder 224 shown in FIG. 2. In the illustrated embodiment, the language model is trained to categorize the branch instruction 305 into one of three categories 311, 312, 313 that correspond to different regions in the space of characteristics of hard-to-predict branch instructions.

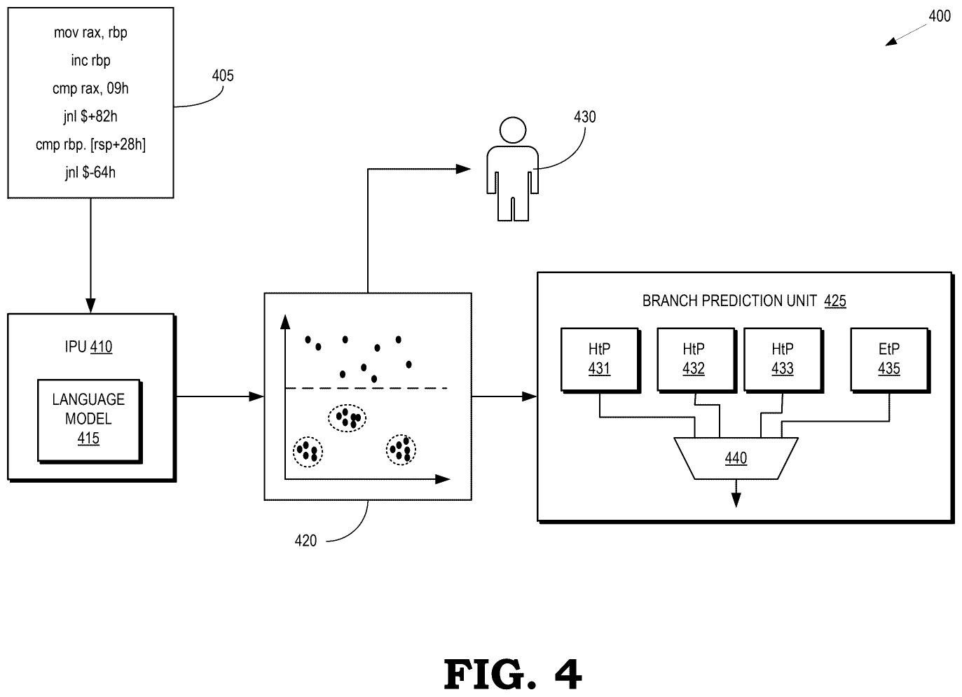

FIG. 4 illustrates a system 400 that implements a method of performing branch prediction for hard-to-predict branch instructions according to some embodiments. The system 400 is implemented in some embodiments of the processing system 100 shown in FIG. 1. In the illustrated embodiment, an instruction sequence 405 is provided to a processing unit such as an IPU 410 that includes circuitry configured to implement and train a language model 415. For example, the IPU 410 can be configured to train the language model 415 using embodiments of the techniques discussed herein. Some embodiments of the IPU 410 are configured with a pre-trained language model 415 and subsequently perform operations such as fine-tuning of the language model 415, online learning for the language model 415, and/or inference based on the language model 415. Other processors such as CPUs, GPUs, GPGPUs, or NPUs can also perform some or all of the training of the language model 415 in some embodiments. The language model 415 can produce model information 420 such as information indicating how to identify easy-to-predict branch instructions or hard-to-predict branch instructions, as well as information indicating characteristics associated with different categories of the hard-to-predict branch instructions. The model information 420 generated by the language model 415 can then be used for purposes including design of branch predictors that are used to predict outcomes of hard-to-predict branch instructions, configuring a branch prediction unit 425, or a combination thereof.

Some embodiments of the system 400 provide the model information 420 to people 430 such as CPU architects that utilize the model information 420 at design time. The CPU architects can use the model information 420 to improve or modify the design of one or more branch predictors. The clusters indicated by the model information 420 reflect branch characteristics and properties that can be used to design specialized predictors that are more effective in predicting the outcomes of the hard-to-predict branch instructions that share these characteristics or properties. In some embodiments, requirements of the CPU architects can be used to construct tasks that are used to train or pretrain the language model 415. Inference may be performed on a compute cluster to exploit the information generated by the language model 415.

The branch prediction unit 425 includes a set of branch predictors including hard-to-predict (HtP) branch predictors 431, 432, 433 and an easy-to-predict (EtP) branch predictor 435. The language model 415 provides the model information 420 to the branch prediction unit 425, which uses the model information 420 to select a subset (such as one) of the branch predictors 431, 432, 433, 435 to perform branch prediction on branch instructions received by the branch prediction unit 425. In some embodiments, the model information 420 is used to configure a data structure 440 to identify and categorize (or support the identification and categorization of) hard-to-predict branch instructions. Although the data structure 440 is depicted as a multiplexer deployed downstream of the branch predictors 431, 432, 433, 435, the data structure 440 can also be used upstream to select one of the branch predictors 431, 432, 433, 435 so that only the selected one of the branch predictors 431, 432, 433, 435 is used to perform branch prediction. In some embodiments, one of the HtP branch predictors 431, 432, 433 is selected to predict the outcome of an instruction that is categorized as hard to predict and the EtP branch predictor 435 is bypassed, thereby preventing state pollution of the EtP branch predictor 435 by the hard-to-predict branch instruction.

In operation, the branch prediction unit 425 uses the model information 420 (e.g., as stored in the data structure 440) to identify the hard-to-predict branch instructions and select an appropriate target branch predictor. Branch instructions that are not classified as hard-to-predict are routed towards the EtP branch predictor 435. In response to identifying a branch instruction as hard-to-predict, the branch prediction unit 425 can categorize the hard-to-predict branch instruction based on the model information 420. The categories of hard-to-predict branch instructions correspond to (or are associated with) different ones of the branch predictors 431, 432, 433. For example, the category 311 shown in FIG. 3 can correspond to the HtP branch predictor 431, the category 312 shown in FIG. 3 can correspond to the HtP branch predictor 432, and the category 313 shown in FIG. 3 can correspond to the HtP branch predictor 433. In response to determining the category of the hard-to-predict branch instruction (i.e., the target category), the branch prediction unit 425 selects a target branch predictor and routes the instruction to the target branch predictor for branch prediction.

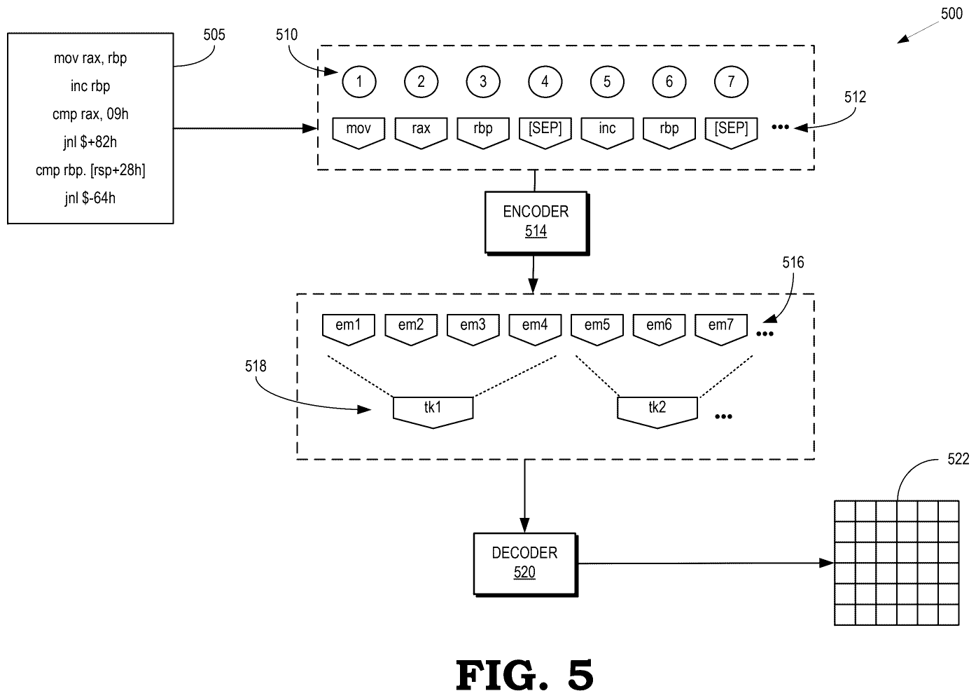

FIG. 5 illustrates a system 500 that implements a method of tokenizing and re-tokenizing branch instructions to identify dependencies between subsets of instructions according to some embodiments. The system 500 is implemented in some embodiments of the processing system 100 shown in FIG. 1. In the illustrated embodiment, an instruction sequence 505 is provided to tokenizing circuitry such as the circuitry 206 shown in FIG. 2. The tokenizing circuitry splits the instruction sequences into tokens 512 that are provided to an encoder 514, as well as generating positional embeddings 510 of the tokens 512 that can also be provided to the encoder 514. The encoder 514 generates embeddings 516 based on the positional embeddings 510 and the tokens 512. Subsets of the embeddings 516 are re-tokenized to form the tokens 518. Thus, the system 500 generates a hierarchy of tokens including the tokens 512 and the tokens 518. The set of tokens 518 are provided to a decoder 520, which generates a self-attention matrix 522 that indicates dependencies between the subsets of instructions associated with the tokens 518.

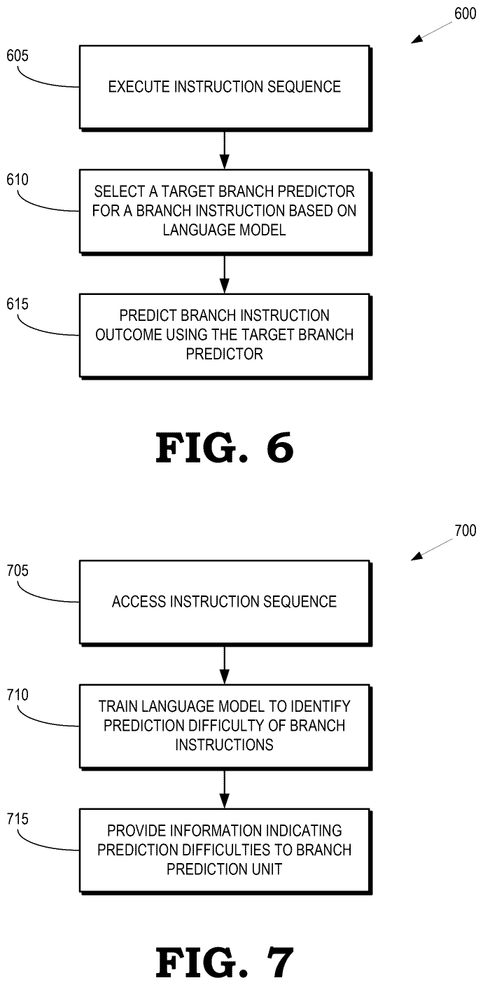

FIG. 6 illustrates a method 600 of predicting outcomes of branch instructions using branch predictors that are selected based on the difficulty of predicting the outcome of the branch instructions, according to some embodiments. The method 600 is implemented in some embodiments of the branch prediction unit 116 shown in FIG. 1 and the branch prediction unit 425 shown in FIG. 4. Branch prediction units that implement the method 600 include a plurality of branch predictors that are used to predict outcomes of branch instructions having different levels of prediction difficulty.

At block 605, a processing unit, such as the CPU 114 shown in FIG. 1, executes a sequence of instructions that includes one or more branch instructions. The branch instructions in the sequence of instructions can have different levels of prediction difficulty. For example, one subset of branch instructions can have a first level of difficulty that is higher than a second level of difficulty of another subset of branch instructions. The outcomes of the branch instructions in the subset having the first level of difficulty are therefore more difficult to predict than the outcomes of the branch instructions in the subset having the second level of difficulty.

At block 610, one of the plurality of branch predictors in the branch prediction unit is selected as a target branch predictor based on a language model. In some embodiments, the branch predictors are associated with corresponding categories of branch instructions. The target branch predictor for a branch instruction is selected in response to the branch prediction unit determining that the branch instruction is in the category associated with the target branch predictor.

At block 615, an outcome of the branch instruction is predicted using the target branch predictor. For example, the target branch predictor can determine whether the branch indicated in the branch instruction is taken or not taken.

FIG. 7 illustrates a method 700 of training a language model to categorize branch instructions based on the difficulty of predicting the outcome of the branch instructions, according to some embodiments. The method 700 is implemented in a processing system such as some embodiments of the CPU 114 or the parallel processor 120 shown in FIG. 1, the system 200 shown in FIG. 2, or the IPU 410 shown in FIG. 4.

At block 705, the processing system accesses an instruction sequence that includes one or more branch instructions. As discussed herein, the branch instructions can have different levels of prediction difficulty so that the difficulty of predicting outcomes of the branch instructions can be higher or lower for different branch instructions.

At block 710, the processing system trains the language model to identify prediction difficulties of branch instructions in the instruction sequence. Some embodiments of the processing system train the language model to identify or categorize the branch instructions as having outcomes that are more or less difficult to predict based on the sequence of instructions. For example, the language model can be trained to determine that some branch instructions have outcomes that have a first difficulty of prediction, while other branch instructions have outcomes that have a second difficulty of prediction that is greater than the first difficulty. The processing system can train the language model using tasks including predicting randomly masked instructions in the sequence of instructions, predicting outcomes of branch instructions in variable length samples of instructions drawn from the sequence, or identifying dependencies between instructions in the sequence of instructions.

At block 715, the processing system provides information indicating the prediction difficulties of different branch instructions to branch prediction unit. In some embodiments, the processing system provides information that indicates characteristics of categories of branch instructions that have outcomes that are harder to predict or easier to predict. As discussed herein, the categories of branch instructions can be associated with branch predictors that are configured to predict outcomes of branch instructions that are harder to predict or easier to predict.

In some embodiments, the apparatus and techniques described above are implemented in a system including one or more integrated circuit (IC) devices (also referred to as integrated circuit packages or microchips), such as the system of branch prediction described above with reference to FIGS. 1-5. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
executing, in a processing unit, a sequence of instructions comprising a branch instruction;
selecting, from a plurality of branch predictors, a target branch predictor for the branch instruction based on a language model trained on one or more training instruction sequences that comprise branch instructions; and
predicting, using the target branch predictor, an outcome of the branch instruction.

2. The method of claim 1, wherein the one or more training instruction sequences comprise a first subset of branch instructions having a first difficulty of prediction and a second subset of branch instructions having a second difficulty of prediction that is greater than the first difficulty, and wherein the language model is trained to identify the first subset of branch instructions and the second subset of branch instructions.

3. The method of claim 2, further comprising:
determining, at the processing unit, whether the branch instruction is in the first subset or in the second subset based on the language model.

4. The method of claim 3, wherein the plurality of branch predictors comprise a first branch predictor configured to predict outcomes of branch instructions in the first subset and at least one second branch predictor configured to predict outcomes of branch instructions in the second subset, and wherein selecting the target branch predictor comprises selecting the first branch predictor in response to the processing unit determining that the branch instruction is in the first subset and selecting the at least one second branch predictor in response to the processing unit determining that the branch instruction is in the second subset.

5. The method of claim 4, wherein selecting the at least one second branch predictor further comprises bypassing branch prediction at the first branch predictor in response to the processing unit determining that the branch instruction is in the second subset.

6. The method of claim 4, wherein the plurality of branch predictors comprises a plurality of second branch predictors configured to predict outcomes of a plurality of categories of branch instructions in the second subset, and wherein the language model is trained to categorize the branch instruction in one of the plurality of categories.

7. The method of claim 6, further comprising:
determining a target category of the branch instruction based on the language model, and wherein selecting the target branch predictor comprises selecting one of the plurality of second branch predictors that is configured to predict outcomes of the target category.

8. An apparatus, comprising:
a processing unit configured to execute a sequence of instructions comprising a branch instruction; and
a plurality of branch predictors, wherein the processing unit is configured to select, from the plurality of branch predictors, a target branch predictor for the branch instruction based on a language model trained on one or more training instruction sequences that comprise branch instructions, and wherein the target branch predictor is configured to predict an outcome of the branch instruction.

9. The apparatus of claim 8, wherein the one or more training instruction sequences comprise a first subset of branch instructions having a first difficulty of prediction and a second subset of branch instructions having a second difficulty of prediction that is greater than the first difficulty, and wherein the language model is trained to identify the first subset of branch instructions and the second subset of branch instructions.

10. The apparatus of claim 9, wherein the processing unit is configured to determine whether the branch instruction is in the first subset or in the second subset based on the language model.

11. The apparatus of claim 10, wherein the plurality of branch predictors comprise a first branch predictor configured to predict outcomes of the first subset of branch instructions and at least one second branch predictor configured to predict outcomes of the second subset of branch instructions.

12. The apparatus of claim 11, wherein the processing unit is configured to select the first branch predictor in response to determining that the branch instruction is in the first subset and select the at least one second branch predictor in response to determining that the branch instruction is in the second subset.

13. The apparatus of claim 12, wherein the plurality of branch predictors comprises a plurality of second branch predictors configured to predict outcomes of a plurality of categories of branch instructions in the second subset.

14. The apparatus of claim 13, wherein the processing unit is configured to categorize the branch instruction in one of the plurality of categories based on the language model.

15. The apparatus of claim 14, wherein the processing unit is configured to determine a target category of the branch instruction based on the language model, wherein the processing unit is configured to select one of the plurality of second branch predictors that is configured to predict outcomes of the target category, and wherein the processing unit is configured to provide the branch instruction to the selected one of the plurality of second branch predictors.

16. A method comprising:
accessing, in a processing unit, a sequence of instructions comprising branch instructions;
training, at the processing unit, a language model to identify the branch instructions as having outcomes having a first difficulty of prediction or outcomes having a second difficulty of prediction that is greater than the first difficulty based on the sequence of instructions; and
providing, from the processing unit to a branch prediction unit, information generated by the language model that is used by the branch prediction unit to determine whether branch instructions have the first difficulty or the second difficulty of prediction.

17. The method of claim 16, wherein training the language model comprises training the language model to identify the branch instructions as having outcomes that have the first difficulty of prediction or outcomes that have the second difficulty of prediction based on a prior control flow history of the branch instructions in the sequence of instructions.

18. The method of claim 16, wherein training the language model comprises pretraining the language model using at least one pretraining decoder that applies at least one task to the sequence of instructions.

19. The method of claim 18, wherein the at least one task comprises at least one of predicting randomly masked instructions in the sequence of instructions, predicting outcomes of branch instructions in variable length samples of instructions drawn from the sequence, or identifying dependencies between instructions in the sequence of instructions.

20. The method of claim 16, wherein training the language model comprises training the language model to identify the branch instructions as having the second difficulty of prediction based on a training dataset that comprises the sequence of instructions and at least one of a branch prediction made by a branch predictor, an outcome of the branch instruction, or a performance metric indicating how hard the outcome is to predict.

21. The method of claim 16, wherein training the language model comprises training the language model to categorize the branch instructions having the second difficulty of prediction into one of a plurality of categories.
